(19) United States
(12) Patent Application Publication
(10) Pub. No.: US 2018/0281074 A1
(43) Pub. Date: Oct. 4, 2018

(54) CANTILEVER-SUPPORTED TUNED DYNAMIC ABSORBER

(71) Applicant: Kennametal Inc., Latrobe, PA (US)

(72) Inventors: Samuel Lawrence Eichelberger, Trafford, PA (US); Tony Schmitz, Matthews, NC (US); Shi Chen, Latrobe, PA (US); Igor Kaufmann, Nürnberg (DE); Ruy Frota de Souza Filho, Latrobe, PA (US); Jeremy Canonge, Monroeville, PA (US)

(21) Appl. No.: 15/476,078

(22) Filed: Mar. 31, 2017

(51) Int. Cl. B23B 27/00

(52) U.S. Cl. CPC B23B 27/002

(57) ABSTRACT

A vibration absorber assembly which includes a cantilever beam component having a proximal end and a distal end, wherein the cantilever beam component extends along a longitudinal axis between the proximal end and the distal end. A distal support element supports the distal end of the cantilever beam component, and an absorber mass is movable in at least a radial direction with respect to the longitudinal axis. First and second support media support the absorber mass with respect to the cantilever beam component. The first support medium contacts the cantilever beam component at a first support region of the cantilever beam component, and the second support medium contacts the cantilever beam component at a second support region of the cantilever beam component, the first and second support regions being located at different longitudinal positions along the cantilever beam component. Other variants and embodiments are broadly contemplated herein.

### BACKGROUND

In metal cutting operations, boring bars are often employed for forming deep bores and/or for enlarging existing holes. Based on work requirements, close tolerances may often be needed with such bores or holes. Generally, a boring bar supports a boring head that may itself have a cutting insert mounted thereupon, or may have one or more cutting edges otherwise integrated or associated with the boring head. In operation, a workpiece may rotate while the boring bar remains stationary, or alternatively the boring bar may rotate while the workpiece rotates or is stationary.

Standard boring bars (e.g., formed from steel and/or carbide) are often not adequate for machining “hard to reach” deep bores, since an extended length-to-diameter ratio is usually needed, which can thereby greatly reduce the stiffness and stability of the boring bar. Particularly, during a metal cutting operation, any vibration (or vibratory motion) between a cutting tool and workpiece may lead to greatly compromised cutting performance, which could result in a poor workpiece surface finish, or a finished workpiece that is out of tolerance. Furthermore, such vibration may cause the cutting tool or the machine tool to become damaged or even to physically break. As an illustrative example of possible damage, vibration may cause micro-chipping of a cutting edge and thereby shorten tool life. Adverse effects such as these can be mitigated or prevented by scaling back on cutting parameters (e.g., on metal removal rate), but of course this can greatly reduce productivity and at best may only have a nominal or negligible effect on reducing the amount of vibration.

To address the above-noted challenges, tuned boring bars have been developed which utilize any of a variety of internal dynamic absorbers. In some known implementations, rubber elements are employed for providing stiffness and viscous damping in an internal dynamic absorber system. However, since viscous damping is a material-specific property, it can be difficult to design the internal dynamic absorber in accordance with specific parameters for desired performance using rubber elements alone.

Accordingly, other implementations of internal dynamic absorbers have involved the use of a heavier mass supported by rubber elements on either end. However, this can give rise to several problems which include the splitting of a reaction force from the absorber into two locations, thereby moving a total effective reaction further away from the actual origin of vibration (e.g., the cutting edge of a cutting insert mounted on the boring bar or other tool).

### SUMMARY

In summary, one aspect of the invention provides a vibration absorber assembly comprising: a cantilever beam component having a proximal end and a distal end, wherein the cantilever beam component extends along a longitudinal axis between the proximal end and the distal end; a distal support element which supports the distal end of the cantilever beam component; an absorber mass which is movable in at least a radial direction with respect to the longitudinal axis; and first and second support media which support the absorber mass with respect to the cantilever beam component; wherein the first support medium contacts the cantilever beam component at a first support region of the cantilever beam component, and the second support medium contacts the cantilever beam component at a second support region of the cantilever beam component; the first and second support regions being located at different longitudinal positions along the cantilever beam component.

Another aspect of the invention provides a cutting tool assembly comprising: a shank portion defining a greater cavity therewithin; a vibration absorber assembly disposed within the greater cavity, the vibration absorber assembly comprising: a cantilever beam component having a proximal end and a distal end, wherein the cantilever beam component extends along a longitudinal axis between the proximal end and the distal end; a distal support element which supports the distal end of the cantilever beam component; an absorber mass which is movable in at least a radial direction with respect to the longitudinal axis; and first and second support media which support the absorber mass with respect to the cantilever beam component; wherein the first support medium contacts the cantilever beam component at a first support region of the cantilever beam component, and the second support medium contacts the cantilever beam component at a second support region of the cantilever beam component; the first and second support regions being located at different longitudinal positions along the cantilever beam component.

For a better understanding of exemplary embodiments of the invention, together with other and further features and advantages thereof, reference is made to the following description, takin in conjunction with the accompanying drawings, and the scope of the claimed embodiments of the invention will be pointed out in the appended claims.

### BRIEF DESCRIPTION OF THE DRAWINGS

FIG. 1 provides a plan view of a boring bar.

FIG. 2 provides a front elevational view of the boring bar of FIG. 1.

FIG. 3 provides a plan cross-sectional view of a boring bar with a cantilever-supported tuned dynamic absorber.

FIG. 4 provides a plan cross-sectional view of a cantilever-supported tuned dynamic absorber for a boring bar, in accordance with a variant embodiment.

FIG. 5 provides a plan cross-sectional view of a boring bar shank with a cantilever-supported tuned dynamic absorber, in accordance with another variant embodiment.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

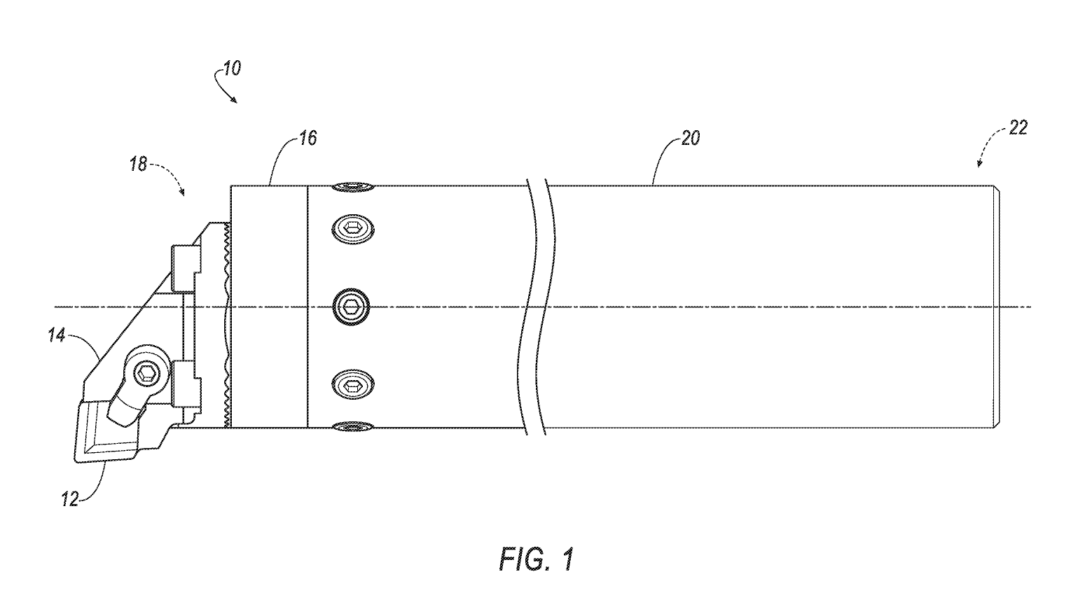

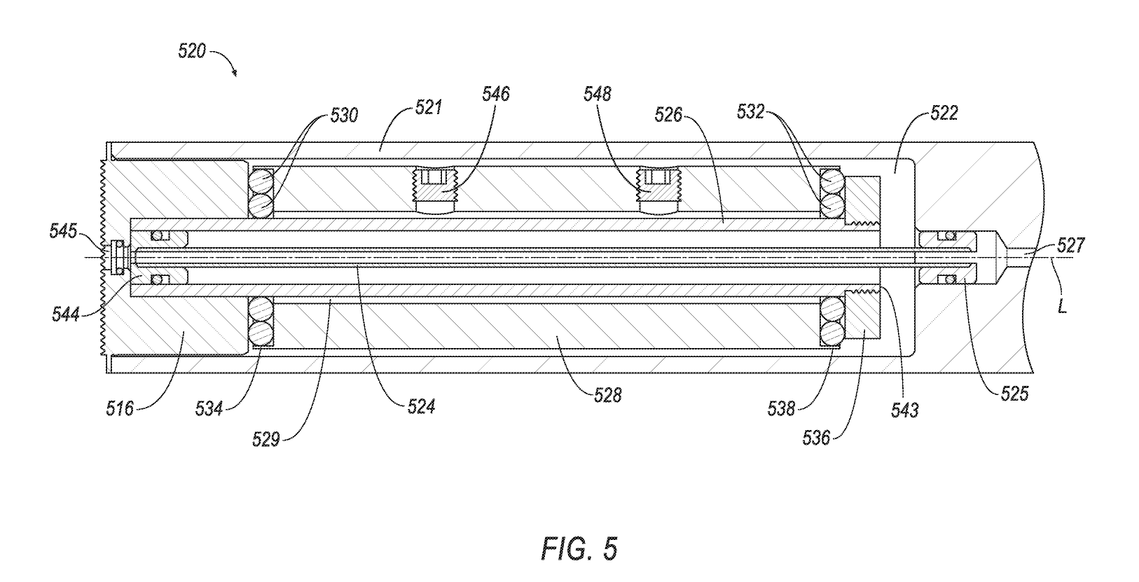

The description now turns to the figures. The illustrated embodiments of the invention will be best understood by reference to the figures. The following description is intended only by way of example and simply illustrates certain selected exemplary embodiments of the invention as claimed herein. To facilitate easier reference, in advancing from FIG. 1 to and through FIG. 5, a reference numeral is advanced by a multiple of 100 in indicating a substantially similar or analogous component or element with respect to at least one component or element found in one or more earlier figures among FIGS. 1-5.

Broadly contemplated herein, in accordance with at least one embodiment, is an internal dynamic absorber for a boring bar, wherein an absorber mass is supported via rubber (or elastomeric) elements placed on a cantilever beam. As the boring bar contacts a workpiece, the absorber mass vibrates with respect to the cantilever beam, which itself redirects most or all of the resultant reaction force toward the front of the boring bar. An overhang length of the cantilever beam can be customized or adjusted to increase or decrease a compressive force with respect to supporting elements (e.g., O-rings). Viscous fluid that fills a cavity between the absorber mass and the cantilever beam can supply viscous damping to the system. Related embodiments and other variants will be better appreciated from the ensuing discussion.

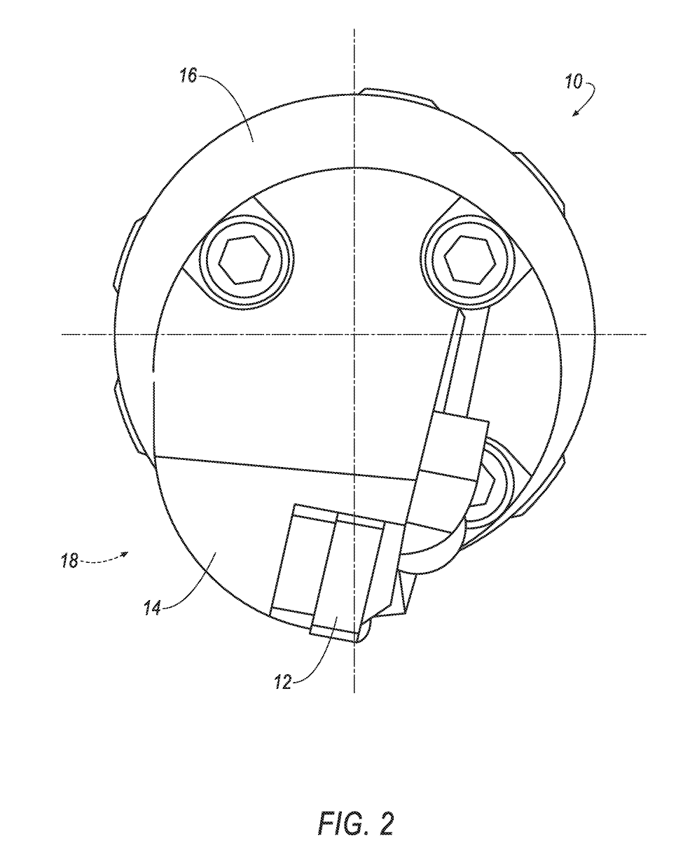

Referring now to FIGS. 1 and 2, a boring bar 10 is shown in accordance with at least one embodiment. Although embodiments as described and contemplated herein are directed to a boring bar 10 for boring deep holes in work pieces, aspects and features as discussed herein may be applied essentially to any cutting tool, or toolholder, that produces vibrations when cutting a work piece (whether the tool or toolholder is stationary with respect to a rotating workpiece, or rotates with respect to a stationary or rotating workpiece). For instance, embodiments as described and contemplated herein may be utilized in milling adapters.

As such, a cutting insert 12 may be mounted in a suitable manner to a head 14, that itself is attached to a collar 16 at a distal end 18 of the boring bar 10. A shank 20 is disposed toward the opposite, proximal end 22 of the boring bar 10. Either or both of the head 14 and shank 20 may be formed from steel, while the cutting insert 12 may be formed from carbide or the like. A longitudinal axis L, defined centrally with respect to the shank 20, extends along the length of the boring bar 10. Proximal end 22 may be fixedly connected to a supporting structure, such as a supporting structure of a metalworking machine (not otherwise illustrated in FIG. 1). The cutting insert 12 may be of essentially any suitable form or configuration, including (but not limited to) that illustrated. Further, it may be formed of essentially any suitable hard cutting material, which may involve carbide but could alternatively involve ceramic, superhards or the like.

Thus, in accordance with at least one embodiment, the boring bar 10 at large may be regarded as a cantilevered beam, wherein the proximal end 22 is secured to the aforementioned supporting structure and the distal end 18 is free. Use of the boring bar 10 in a metalworking operation will produce vibrations that travel through the boring bar 10, thereby affecting the stability of the cutting process. In accordance with at least one embodiment, the boring bar 10 is provided with a dynamic absorber which includes an absorber mass and supporting elastomeric elements, discussed in further detail herebelow, that will serve to dampen the vibrations traveling through the boring bar 10. (The elastomeric elements discussed herein, e.g., as indicated at 330/332, 430/432 and 530/532 in the figures, may be formed from rubber or a similarly/analogously elastic or elastomeric material.)

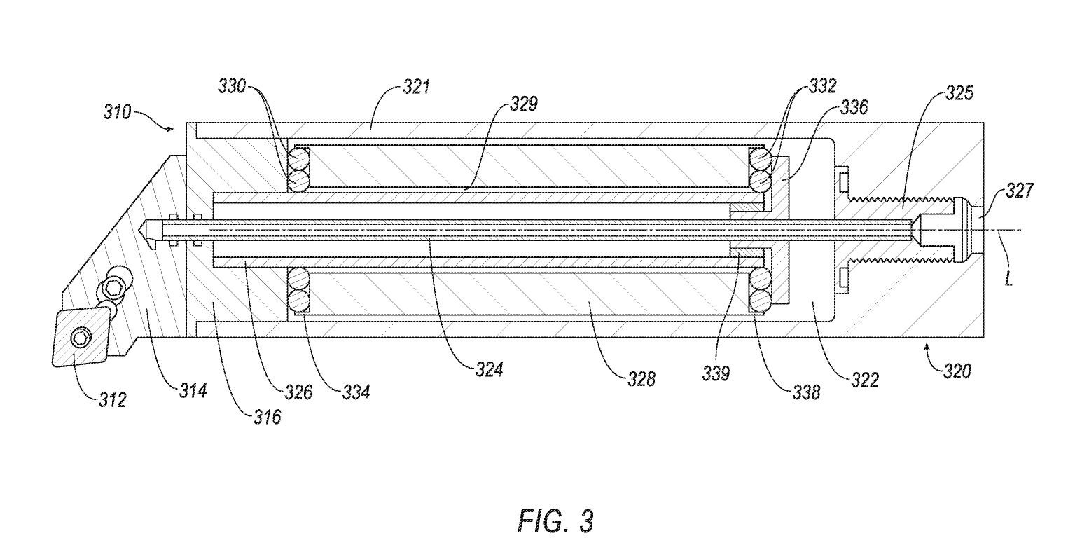

Referring now to FIG. 3, which shows a boring bar 310 in accordance with at least one embodiment, shank 320 defines a central cavity 322 therewithin, extending from collar 316 toward a proximal end of the shank 320. More particularly, a hollow (generally) cylindrical-shaped sleeve 321 of shank 320, extending from the proximal end of shank 320, provides space for the central cavity 322, and for most or all of the collar 316 therewithin. Sleeve 321 may assume a shape that is generally, substantially or approximately cylindrical, but can alternatively assume any of a wide variety of other suitable shapes. Preferably, an outer cylindrical surface of at least a major portion of collar 316 is press-fit with respect to the inner cylindrical surface of sleeve 321, or otherwise is in mutual physical engagement therewith via some other suitable attachment mechanism such as brazing.

Also shown is a coolant tube 324 (e.g., formed from a steel) extending along the central longitudinal axis L, for providing coolant proximate the cutting insert 312. At a proximal end, the coolant tube 324 is supported by a proximal end portion of shank 320 via a coolant tube adapter 325 that is nested within, and concentric with respect to, the shank 320. Among other things, the adapter 325 may interface with a proximal coolant inlet 327 of the shank 320 to help direct coolant into the proximal end of the coolant tube 324. In accordance with at least one variant embodiment, the coolant tube 324 may be omitted.

In accordance with at least one embodiment, as shown, a cylindrically-shaped hollow cantilever beam 326 extends longitudinally through central cavity 322. The cantilever beam has an inner diameter that is greater than the outer diameter of coolant tube 324, and is concentric with respect to coolant tube 324. A distal end of beam 326 may be inserted into a compatible cylindrical recess in collar 316, with a proximal end of beam 326 (toward the right of the figure) essentially being free. The cantilever beam 326 can be secured to the collar 316 by press fitting, brazing, welding, and/or the like. In the illustrated embodiment, the cantilever beam 326 is press fit into the collar 316.

As such, in accordance with at least one embodiment, a cylindrically-shaped, hollow absorber mass 328 may be supported on cantilever beam 326 via the interposition of rubber/elastomeric O-rings 330/332. The absorber mass 328 has an inner diameter greater than the outer diameter of the cantilever beam 326, and is concentric with respect to the cantilever beam 326. By way of illustrative and non-restrictive example, the absorber mass 328 may be formed from a material of higher density such as a heavy metal, e.g., copper, lead, or another metal. An annular cavity 329 is thereby defined and bounded between an internal cylindrical surface of the absorber mass 328, an external cylindrical surface of the cantilever beam 326 and, on either axial side, by a respective one or more of the O-rings 330/332. This annular cavity 329 can be filled with a suitable viscous damping fluid to impart viscous damping in a context of relative movement between absorber mass 328 and cantilever beam 326. (It should be appreciated and understood that the O-rings shown throughout the figures, and as indicated at 330/332, 430/432 and 530/532 in FIGS. 3-5, are depicted in a manner for illustrative purposes only, and that in an actual assembled state of a boring bar they will each compress with respect to adjacent objects and thereby will each likely assume a cross-sectional shape that is not necessarily circular.)

As shown, a first pair of concentric, mutually contacting and nested O-rings 330 may be interposed between a distal axial end of absorber mass 328 and a proximal axial face of collar 316. In a radial direction (with respect to axis L), the O-rings 330 may also be bounded by a small circumferentially extending flange 334 of absorber mass 328 and the external cylindrical surface of cantilever beam 326. Further, a second pair of concentric, mutually contacting and nested O-rings 332 may be interposed between a proximal axial end of absorber mass 328 and a distal axial face of a cap 336. In a radial direction (with respect to axis L), the O-rings 332 may also be bounded by a (second) small circumferentially extending flange 338 of absorber mass 328 and the external cylindrical surface of cantilever beam 326.

It should thus be appreciated that, in accordance with at least one embodiment, the absorber mass 328 is supported within the cavity 332 solely by cantilever beam 326. In the illustrated embodiment, the cantilever beam 326 is made of a suitable material to provide some stiffness or rigidity, but to allow the absorber mass 328 to move within the cavity 332. Thus, the beam 326 is preferably formed from a material that is high in stiffness but low in density. For example, the cantilever beam 326 can be made of a relatively strong metal material, such as tungsten or the like. In the illustrated embodiment that includes the coolant tube 324, the cantilever beam 326 is cylindrical-shaped and hollow, to permit to allow the coolant tube 324 to pass through the cantilever beam 326. Preferably, the coolant tube 324 does not provide any additional support for the absorber mass 328. In addition, it should be noted that the absorber mass 328 does have an outer diameter that is smaller than an inner diameter of the central cavity 322, thus permitting the absorber mass 328 to freely move in essentially any radial direction with respect to the longitudinal axis L.

For applications in which the boring bar 310 is particularly large, steel may be used for cantilever beam 326 in place of a heavier metal. Put another way, for such applications, a significant overhang length of beam 326 (i.e., the length of that portion of the beam 326 that is unsupported) may lend itself better to a metal, such as steel, that is less dense and has a lower modulus of elasticity. In accordance with yet another variant embodiment, beam 326 may be formed from a carbon fiber composite. In accordance with still another variant embodiment, especially in smaller-scale applications, beam 326 may be formed from a ceramic (e.g., silicon carbide).

As such, and particularly in applications where the cantilever beam 326 is formed from a ceramic, cap 336 may include an axially extending hollow cylindrical projection. Depending on the desired application or implementation, an inner cylindrical surface of this axially extending hollow cylindrical projection may or may not contactingly engage the outer cylindrical surface of coolant tube 324. In one embodiment, the cap 336 (via its axially extending hollow cylindrical projection) does not contact the outer diameter of the coolant tube 324. In a variant embodiment, there may be contact as illustrated in FIG. 3, whereupon a small amount of support is provided to the proximal/free end of the cantilever beam 326, but preferably such extra support is less stiff than the stiffness of the distal/fixed end of the cantilever beam 326 in order to transmit the majority (preferably, the great majority) of the reaction force toward the front/distal end of the boring bar 310. In one or more variant embodiments involving the aforementioned contact, the inner cylindrical surface of the axially extending hollow cylindrical projection of cap 336 may be adhered, e.g., via epoxy, to an outer cylindrical surface of coolant tube 324.

Whether or not there is contact with coolant tube 324, the aforementioned axially extending hollow cylindrical projection (of cap 336) may have an outer cylindrical surface that is threaded to engage a compatibly (internally) threaded adapter ring 339, itself shown in FIG. 3. Adapter ring 339 is annular or cylindrical in shape, and the outer cylindrical surface thereof can be form-fit with respect to an inner cylindrical surface of cantilever beam 326.

It will be appreciated that, with the configuration as shown in FIG. 3 and analogously functioning configurations, since a dynamic absorber comprising absorber mass 328 and O-rings 330/332 only makes contact with the cantilever beam 326, it will be the case that during operation (and resultant vibration of the boring bar 310 at large) the cantilever beam 326 will supply all or virtually all of a resultant reaction force. Therefore, all or virtually all of the forces transmitted from the absorber mass 328 to the cantilever beam 326 are in turn transmitted toward the distal, fixed end of the beam 326 (i.e., right to left in the figure and essentially in parallel to axis L). Effectively, most or all of a reaction force and a reaction moment resulting from tool vibration are concentrated at the distal, fixed end of beam 326. Since the distal, fixed end of the beam 326 in turn is relatively close to the cutting edge of the insert 312, where the vibration during operation originates from contact with a workpiece, vibration damping and stability of the boring bar 310 are greatly improved as compared to an arrangement where the reaction forces are not so transmitted and concentrated.

Preferably, as much of the aforementioned reaction force as possible is transmitted from the absorber mass 328 to the cantilever beam 326, and then toward the distal end of beam 326. Generally, this transmission can represent substantially 100% of the reaction force involved. In accordance with at least one variant embodiment, some form of additional physical support may be provided to the cantilever beam 326 at a proximal end thereof, sufficient to help prevent excessive deflection of the beam 326, where a small portion of the reaction force is absorbed (e.g., less than about 5% of the reaction force, or in at least one variant, less than about 10% of the reaction force). Such a physical support could assume essentially any suitable form, e.g., a small component supported by a proximal end of shank 321 that in turn supports a portion of beam 326 at or near the proximal end of beam 326. One possible specific implementation of such additional physical support (purely by way of illustrative and non-restrictive example) is discussed hereabove with respect to the axially extending hollow cylindrical projection of cap 336. Whatever the form assumed by the additional physical support, an advantage can still be maintained via directing the great majority of the aforementioned reaction force (e.g., about 90% or more to about 95% or more) toward the distal end of beam 326 and closer to the region of physical contact between the bar 310 and a workpiece. However, it should generally be appreciated that sufficient support of the beam 326 at its distal, fixed end can help ensure that additional physical support at (or near) the proximal end of beam 326 essentially becomes superfluous or unnecessary.

In accordance with at least one embodiment, the cantilever beam 326 can be customized or adjusted to tailor the compressive force provided to the rubber/elastomeric element (O-ring) supports 330/332. Such customization or adjustment can include tailoring the length of the cantilever beam 326, or of that portion of cantilever beam 326 that extends away from the collar 316 and thus is free (“overhang length”), or both. It is also possible to tailor damping, and the dissipation of reaction forces during vibration, via adjusting or tailoring the stiffness of O-rings 330/332; one useful application here would involve tuning to a specified natural frequency of the absorber mass 328 prior to the introduction of viscous fluid into cavity 329.

As such, cavity 329 is preferably filled with a suitable viscous fluid for providing viscous damping of movement of the absorber mass 328 with respect to the cantilever beam 326. The amount or degree of viscous damping can be tailored via the viscosity of the fluid actually employed, and the degree to which the cavity 329 is filled with the viscous fluid. Thus, beyond the choice of viscous fluid, the cavity 329 could be filled as deemed suitable for the application at hand, e.g., to a full 100% of its volume or to a lesser extent (e.g., to between about 70% to about 80% of its volume).

Generally, the maximum overhang length available to the cantilever beam 326 is governed largely by the stiffness of O-rings 330/332, as the O-rings 330/332 initially absorb the bulk of the forces transmitted by motion of absorber mass 328. Thus, by way of an illustrative working example, if the O-rings 330/332 are configured (collectively) with a stiffness of 2 N/m, then cantilever beam 326 could be configured such that its proximal, free end has a stiffness of up to 6 N/m, yet with its vibration (and potential deflection) still kept within non-detrimental limits. With various parameters or properties assumed constant, such as the material of beam 326, inner and outer diameter of beam 326, and length of the beam 326 that is held fixed by a support (e.g., collar 316) at a distal end of the beam 326, the permissible maximum overhang length of beam 326 can be understood as having a stiffness at its proximal/free end being governed by a multiplier (e.g., about 3) of the stiffness of O-rings 330/332. Of course, the reverse may apply in given applications; e.g., the overhang length of beam 326 can be understood as constant with one or more other parameters (e.g., non-overhang length of beam 326, material of beam 326, inner/outer diameter of beam 326) being understood as variable in the context of the constraint provided by the overhang length of beam 326.

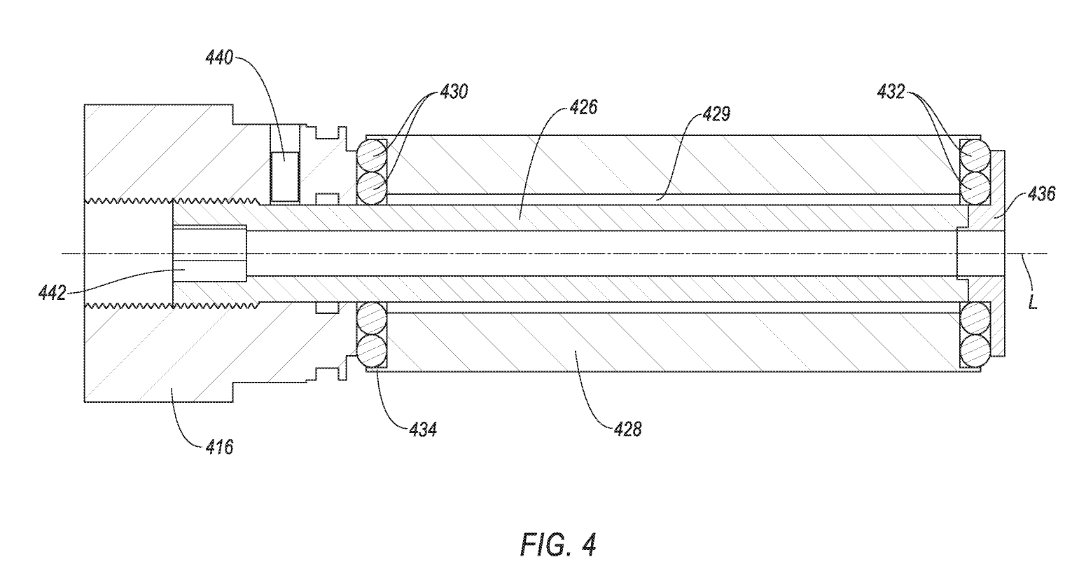

Generally, the embodiment of FIG. 3 and any and all analogous embodiments may be understood as providing for “pre-set” parameters, that more or less can be understood as “fixed” once the bar 326 is completely assembled. However, FIG. 4 illustrates a variant embodiment where one or more “tunable” parameters are availed. (A head, cutting insert and shank are not shown in FIG. 4, as otherwise were shown in the embodiment of FIG. 3. Also, there is no coolant tube shown as in the embodiment of FIG. 3, but it can be understood that essentially any coolant tube suitably configured and disposed, e.g., such as that indicated at 324 in FIG. 3, may be employed here.) As such, the example embodiment of FIG. 4 also shows components 440/442 which may be employed to adjust and set a longitudinal position of cantilever beam 426 with respect to axis L. Particularly, one or more set screws 440 may each be disposed in their own radially-extending bore in collar 416, configured to lock a longitudinal position of cantilever beam 426 (which itself may include one or more corresponding recesses for accommodating the set screw[s] 440). Further, a socket 442 for accommodating a hex wrench (or the like) may be disposed within the distal end of cantilever beam 426. As such, there may be a threaded connection between collar 416 and the distal end of cantilever beam 426, wherein a relative longitudinal position between the two may be adjusted via engagement of a hex wrench with socket 442, then fixed via engagement of set screw(s) 440 with beam 426.

FIG. 5 illustrates another variant embodiment, similar to that of FIG. 3, in which some components are modified. (A head and cutting insert are not shown in FIG. 5, as otherwise were shown in the embodiment of FIG. 3.) Here, an end cap 536 again constrains the cantilever beam 526, absorber mass 528 and O-rings 530/532 with respect to one another, but here is internally threaded to engage with external threads on a narrowed flange/neck portion 543 of beam 526. (Alternatively, the end cap 536 could be disposed on the narrowed flange/neck portion 543 of beam 526 in another manner, e.g., via force-fit.) Thus, cap 536 has no axially extending hollow cylindrical projection as in the case of FIG. 3, nor is there any adapter ring (such as at 339 in FIG. 3) with which such a projection would engage.

By way of another difference with respect to FIG. 3, also shown in the example embodiment of FIG. 5 is a second coolant tube adapter 544 that is nested within, and concentric with respect to, the distal end of cantilever beam 526. Analogously to the adapter 525, distal adapter 544 may interface with a distal coolant outlet 545 of shank 520, to help direct coolant to a head which supports a cutting insert (e.g., such as the head and insert indicated at 314/312 in FIG. 3). An advantage here is that, with the tube 544 not projecting out toward the front of the boring bar in general, it is less likely to be damaged. Also shown are ports 546 and 548 that may be provided, with removable threaded caps, for permitting the introduction of oil or other viscous damping fluid into cavity 529.

In brief recapitulation, it may be appreciated from the foregoing that, in accordance with at least one embodiment as broadly contemplated herein, a vibration absorber assembly includes a cantilever beam component (e.g., a cantilever beam as discussed herein) having a proximal end and a distal end, wherein the cantilever beam component extends along a longitudinal axis between the proximal end and the distal end. A distal support element (e.g., a collar as discussed herein) supports the distal end of the cantilever beam component, and an absorber mass is movable in at least a radial direction with respect to the longitudinal axis.

In further recapitulation, in accordance with at least one embodiment as broadly contemplated herein, first and second support media support the absorber mass with respect to the cantilever beam component. These support media may include O-rings as discussed herein, one or more at each of two different locations, or may include other types of support media that are integral with or separate from the absorber mass. For instance, one or more integral extensions of the absorber mass itself, supported on a cantilever beam component, could constitute support media. The first support medium contacts the cantilever beam component at a first support region of the cantilever beam component, and the second support medium contacts the cantilever beam component at a second support region of the cantilever beam component, the first and second support regions being located at different longitudinal positions along the cantilever beam component.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

1. (canceled)

2. The cutting tool assembly according to claim 20, comprising:
an inner cavity defined between the absorber mass, the cantilever beam component and the first and second support media;
wherein the inner cavity accommodates a viscous damping fluid.

3. (canceled)

4. The cutting tool assembly according to claim 20, whereby at least about 95% of a force generated by movement of the absorber mass is transmitted to the cantilever beam component and toward the first end of the cantilever beam component.

5. The cutting tool assembly according to claim 20, whereby substantially all of a force generated by movement of the absorber mass is transmitted to the cantilever beam component and toward the distal first end of the cantilever beam component.

6. The cutting tool assembly according to claim 20, wherein the second end of the cantilever beam component is free and unsupported.

7. The cutting tool assembly according to claim 20, wherein the first and second support media each comprise one or more components which are separate from the absorber mass.

8. The cutting tool assembly according to claim 7, wherein either or both of the first and second support media comprise one or more O-rings.

9. The cutting tool assembly according to claim 8, wherein the one or more O-rings are formed from an elastomeric material.

10. The cutting tool assembly according to claim 7, wherein each of the first and second support media comprises one or more O-rings.

11. The cutting tool assembly according to claim 20, wherein the cantilever beam is formed from a high-stiffness, low-density material.

12. The cutting tool assembly according to claim 11, wherein the cantilever beam is formed from a material selected from the group consisting of:
tungsten, and
a metal material, other than tungsten, which is heavier than steel.

13. The cutting tool assembly according to claim 11, wherein the cantilever beam is formed from a material selected from the group consisting of: steel, a ceramic, and a carbon fiber composite.

14. The cutting tool assembly according to claim 20, comprising:
an end cap which is disposed at, and is fixedly engaged with, the second end of the cantilever beam component;
wherein the end cap contacts the second support medium to hold the cantilever beam component and the absorber mass in an initial, fixed position with respect to one another.

15. The cutting tool assembly according to claim 20, wherein the absorber mass is disposed about, and is concentric with respect to, the cantilever beam component.

16. The cutting tool assembly according to claim 20, wherein the first support region of the cantilever beam component is disposed adjacent to the first support element.

17. The cutting tool assembly according to claim 20, wherein the second support region of the cantilever beam component is disposed adjacent to the second end of the cantilever beam component.

18. The cutting tool assembly according to claim 20, wherein the cantilever beam component provides support for the absorber mass solely via the first and second support media.

19. The cutting tool assembly according to claim 20, wherein the first support element comprises a collar for interfacing with a cutting tool head.

20. A cutting tool assembly comprising:
a shank portion defining a central cavity therewithin;
a vibration absorber assembly disposed within the central cavity, the vibration absorber assembly comprising:
a cantilever beam component having a first end and a second end, wherein the cantilever beam component extends along a longitudinal axis between the first end and the second end;
a first end support element which supports the first end of the cantilever beam component;
an absorber mass which is movable in at least a radial direction with respect to the longitudinal axis; and
first and second support media which support the absorber mass with respect to the cantilever beam component;
wherein the first support medium contacts the cantilever beam component at a first support region of the cantilever beam component, and the second support medium contacts the cantilever beam component at a second support region of the cantilever beam component;
the first and second support regions being located at different longitudinal positions along the cantilever beam component
whereby at least about 90% of a force generated by movement of the absorber mass is transmitted to the cantilever beam component and toward the first end of the cantilever beam component.

21. The cutting tool assembly according to claim 20, wherein the cantilever beam component is supported with respect to the shank solely at the first end of the cantilever beam component.
